(19) United States
(12) Patent Application Publication
(10) Pub. No.: US 2017/0222754 A1
(43) Pub. Date: Aug. 3, 2017

(54) ERROR CORRECTING CODING METHOD BASED ON CROSS-LAYER ERROR CORRECTION WITH LIKELIHOOD RATIO AND APPARATUS THEREOF

(71) Applicant: LG ELECTRONICS INC., Seoul (KR)

(72) Inventors: Kwangseok NOH, Seoul (KR); Ilmu BYUN, Seoul (KR); Dongkyu KIM, Seoul (KR)

(73) Assignee: LG ELECTRONICS INC., Seoul (KR)

(21) Appl. No.: 15/009,234

(22) Filed: Jan. 28, 2016

(51) Int. Cl. H04L 1/00

(52) U.S. Cl. CPC H04L 1/0045; H04L 1/0057; H04L 1/0061

(57) ABSTRACT

A data decoding method using an error correction method based on a log-likelihood ratio (LLR) is disclosed. The method includes decoding a transport block based on a first error correction code, calculating a log-likelihood ratio (LLR) for each symbol of the decoded data, when the CRC of the decoded data fails, transmitting information of a symbol determined as error based on the LLR and the decoded transport block to a higher layer, and decoding the information of the symbol determined as error and the transport block based on a second error correction code, in a higher layer.

### BACKGROUND OF THE INVENTION

Field of the Invention

The present invention relates to an error correcting coding method in a wireless communication system, and more particularly, to an error correcting coding method based on cross-layer error correction with a likelihood ratio.

Discussion of the Related Art

Wireless communication systems have been widely deployed in order to provide various types of communication services including voice and data services. In general, a wireless communication system is a multiple access system that can support communication with multiple users by sharing available system resources (a bandwidth, transmission power, etc.). Examples of multiple access systems include code division multiple access (CDMA), frequency division multiple access (FDMA), time division multiple access (TDMA), orthogonal frequency division multiple access (OFDMA), single carrier frequency division multiple access (SC-FDMA), multi carrier frequency division multiple access (MC-FDMA), etc.

Broadcast systems as well as the aforementioned communication systems have necessarily used a channel code. As a general method for configuring a channel code, a transmitting end can encode an input symbol using an encoder and transmitted the encoded symbol. In addition, for example, a receiving end can receive the encoded symbol and decode the received symbol to restore the input symbol. In this case, the size of the input symbol and the size of the encoded symbol can be defined in different ways according to a communication system. For example, in a turbo code for data information used in a long term evolution (LTE) communication system of a 3^{rd} generation partnership project (3GPP), the size of the input symbol is a maximum of 6144 bits and the size of the encoded symbol is 18432 (6144*3) bites. Turbo coding in an LTE communication system may be referred to by the 3GPP technical standard 36.212.

However, the LTE turbo code has characteristics whereby enhancement in performance is slight when a signal to noise ratio (SNR) exceeds a predetermined range even if being increased due to a structure of the code. In this regard, a code with a low error rate as possible can be considered, but in this case, complexity is increased.

A high error rate in a communication system can cause retransmission of unnecessary data and failure in channel reception. In addition, a code with excessively high complexity can cause delay in transmission and reception as well as can increase loads of a base station and a user equipment (UE). In particular, a next-generation communication system that requires rapid transmission and reception of data as possible requires the aforementioned problems. Accordingly, there is a need for a coding method with a low error rate and low complexity.

### SUMMARY OF THE INVENTION

Accordingly, the present invention is directed to an error correcting coding method based on cross-layer error correction with a likelihood ratio and an apparatus thereof that substantially obviates one or more problems due to limitations and disadvantages of the related art.

An object of the present invention is to provide an error correcting coding method for effective communication.

Another object of the present invention is to provide an error correcting coding method with a low error rate and low complexity.

A further object of the present invention is to provide an apparatus for supporting these methods.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for decoding data of a receiving end includes receiving data from a transmitting end, decoding a transport block from the received data based on a first error correction code in a physical layer, determining whether error occurs in each of symbols in the transport block based on a log-likelihood ratio (LLR) for each of the symbols, performing cyclic redundancy check (CRC) on the transport block, when the CRC fails, transmitting together a transport block in which at least one symbol determined as error is erased and information about the at least one erased symbol, to a higher layer, and decoding the transmitted transport block based on the information about the at least one erased symbol according to a second error correction code, in the higher layer.

The first error correction code may be a turbo code.

The second error correction code may be a repetition accumulate (RA) code, a Reed-Solomon (RS) code, or a polar code.

The performing of the CRC may include performing the CRC on the entire transport block or a header of the transport block.

Each of the symbols may be configured with 1 bit having a first value and a second value.

The determining of whether error occurs in each of the symbols may include determining that the symbol as error when an absolute value of a difference between a first Euclidean distance between a value of a symbol and an average value of the first value and a second Euclidean distance between a value of the symbol and an average value of the second value is less than a preset threshold value.

The determining of whether error occurs in each of the symbols may be performed according to the following equation,

$$\vert log \frac{p ( z \vert b = + 1 )}{p ( z \vert b = - 1 )} \vert < α$$

where b is a bit value modulated in the transmitting end, z is a symbol in the transport block, and α is the preset threshold value, and a possibility function p may have a form of additive white Gaussian noise (AWGN).

The preset threshold value may be set to be increased as a signal-to-noise ratio (SNR) of a channel that receives the data is increased.

In another aspect of the present invention, a receiver includes a transceiver configured to transmit and receive a signal, and a processor configured to control the transceiver, wherein the processor is further configured to receive data from a transmitting end, configured to decode a transport block from the received data based on a first error correction code in a physical layer, configured to determine whether error occurs in each of symbols in the transport block based on a log-likelihood ratio (LLR) for each of the symbols, configured to perform cyclic redundancy check (CRC) on the transport block, configured to, when the CRC fails, transmit together a transport block in which at least one symbol determined as error is erased and information about the at least one erased symbol, to a higher layer, and configured to decode the transmitted transport block based on the information about the at least one erased symbol according to a second error correction code, in the higher layer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating physical channels used in a 3GPP system and a general signal transmitting method using the same;

FIG. 2A illustrates a frame structure type 1;

FIG. 2B illustrates a frame structure type 2;

FIG. 3 is a diagram illustrating a resource grid for a downlink slot;

FIG. 4 illustrates a structure of a UL subframe;

FIG. 5 illustrates a structure of a DL subframe;

FIG. 6 illustrates a subframe structure of an LTE-A system according to cross carrier scheduling;

FIG. 7 is a diagram illustrating an encoding procedure according to an embodiment of the present invention;

FIG. 8 illustrates an error rate according to a signal-to-noise ratio (SNR);

FIG. 9 illustrates an example of an RA code encoder;

FIG. 10A illustrates processing of error data according to a UDP protocol;

FIG. 10B illustrates processing of error data according to a UDP-Lite protocol;

FIG. 11 is a flowchart of a decoding method according to an embodiment of the present invention; and

FIG. 12 is a diagram illustrating structures of a base station and a user equipment according to an embodiment of the present invention.

### DETAILED DESCRIPTION OF THE INVENTION

The following embodiments are formed by combining components and features of the present invention in a predetermined form. The components or features may be selectively considered unless otherwise indicated herein. The components or the features may be implemented without being combined with other components or features. In addition, some components and/or features may be combined to configure embodiments of the present invention. An order of described operations in the embodiments of the present invention may be changed. Some components or features of an embodiment may be included in another embodiment or may be substituted with corresponding components or features of another embodiment.

With regard to a description of the drawings, procedures or steps that may obscure the present invention will not be described and procedures or steps that are understandable by one of ordinary skill in the art will not be described.

The embodiments of the present invention are disclosed on the basis of a data communication relationship between a base station and a mobile station. In this case, the base station is used as a terminal node of a network via which the base station can directly communicate with the mobile station. Specific operations to be conducted by the base station in the present invention may also be conducted by an upper node of the base station as necessary.

In other words, it will be obvious to those skilled in the art that various operations for enabling the base station to communicate with the mobile station in a network composed of several network nodes including the base station will be conducted by the base station or other network nodes other than the base station. The term “base station (BS)” may be replaced with a fixed station, Node-B, eNode-B (eNB), or an access point as necessary.

The term “terminal” may be replaced with the terms user equipment (UE), mobile station (MS), subscriber station (SS), mobile subscriber station (MSS), mobile terminal, and advanced mobile station (AMS) as necessary.

In addition, a transmitting end may refer to a fixed and/or mobile node that provides a data service or a voice service and a receiving end may refer to a fixed and/or mobile node that receives a data service or a voice service. Accordingly, in uplink, a mobile station may be a transmitting end and a base station may be a receiving end. Similarly, in downlink, a mobile station may be a receiving end and a base station may be a transmitting end.

Embodiments of the present invention can be supported by standard documents disclosed in at least one of an IEEE 802.xx system, a 3^{rd} generation partnership project (3GPP) system, a 3GPP LTE system, and a 3GPP2 system, which are wireless access systems, and in particular, the embodiments of the present invention can be supported by 3GPP TS 36.211, 3GPP TS 36.212, 3GPP TS 36.213, and 3GPP TS 36.321 documents. That is, obvious steps or parts that are described in the embodiments of the present invention can be understood with reference to the above documents. In addition, all terms stated in the specification can be described in the above standard documents.

The present invention will now be described more fully with reference to the accompanying drawings, in which exemplary embodiments of the present invention are shown. The detailed description to be described with reference to the accompanied drawings is given to describe exemplary embodiments of the present invention and is not given to describe unique embodiment of the present invention.

In addition, specific terms used in the embodiments of the present invention are provided to understand the embodiments of the present invention and use of the specific terms can be changed in different forms without departing from the spirit or scope of the inventions.

For example, a self-interference signal can be used with the same meaning as an interference signal in the embodiments of the present invention. In particular, without other description, an interference signal is a self-interference signal and refers to a signal that is transmitted by a transmission antenna of a specific terminal or base station and received by a reception antenna of the terminal or base station.

The following technology can be applied to a variety of wireless access technologies, for example, code division multiple access (CDMA), frequency division multiple access (FDMA), time division multiple access (TDMA), orthogonal frequency division multiple access (OFDMA), single carrier frequency division multiple access (SC-FDMA), and the like.

CDMA may be embodied through wireless (or radio) technology such as universal terrestrial radio access (utra) or CDMA2000. TDMA may be embodied through wireless (or radio) technology such as global system for mobile communication (GSM)/general packet radio service (GPRS)/enhanced data rates for GSM evolution (EDGE). OFDMA may be embodied through wireless (or radio) technology such as institute of electrical and electronics engineers (IEEE) 802.11 (Wi-Fi), IEEE 802.16 (WiMAX), IEEE 802-20, and evolved UTRA (E-UTRA).

UTRA is a part of universal mobile telecommunications system (UMTS). 3rd generation partnership project (3GPP) long term evolution (LTE) is a part of E-UMTS (Evolved UMTS), which uses E-UTRA. 3GPP LTE employs OFDMA in downlink and employs SC-FDMA in uplink. LTE-Advanced (LTE-A) is an evolved version of 3GPP LTE. For clarity, the following description focuses on 3GPP LTE/LTE-A. However, technical features of the present invention can be applied to an IEEE 802.16e/m system, etc.

In a wireless access system, a user equipment (UE) receives information from an eNB in downlink (DL) and transmits information to an eNB in uplink (UL). Information that is transmitted and received by the eNB and the UE includes general data information and various control information items and there are various physical channels according to a type/use of the information that is transmitted and received by the eNB and the UE.

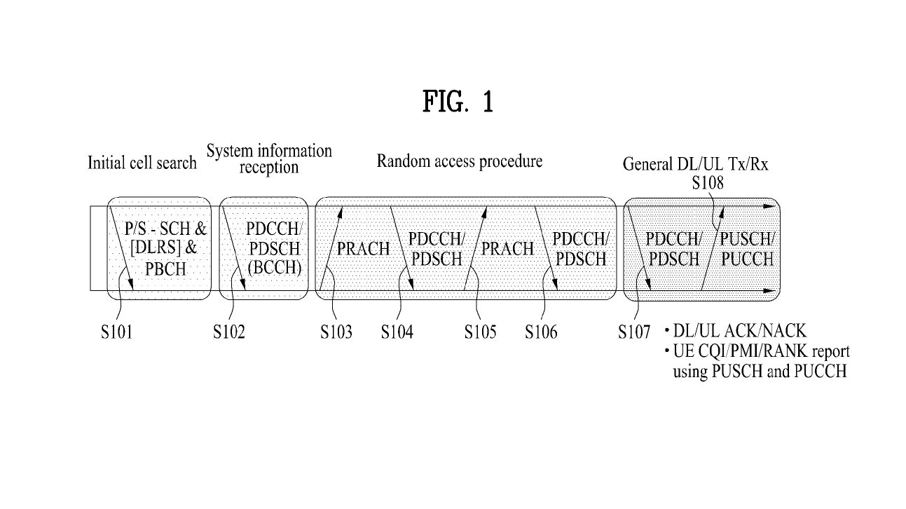

FIG. 1 is a diagram illustrating physical channels used in a 3GPP system and a general signal transmitting method using the same.

If a UE is powered on or newly enters a cell, the UE performs an initial cell search operation such as synchronization with a base station (S101). The UE receives a primary synchronization channel (P-SCH) and a secondary synchronization channel (S-SCH) from the base station so as to synchronize with the base station and to acquire information such as a cell ID. Thereafter, the UE may receive a physical broadcast channel from the base station so as to acquire a broadcast signal in the cell. The UE may receive a downlink reference signal (DL RS) so as to check a downlink channel state in the initial cell search step.

The UE, upon completion of initial cell search, may receive a Physical Downlink Control Channel (PDCCH) and a Physical Downlink Shared Channel (PDSCH) according to information carried in the PDCCH so as to acquire more detailed system information (S102).

When the UE initially accesses the base station or when radio resources for signal transmission are not present, the UE may perform a random access procedure (RACH) with respect to the base station (steps S103 to S106). The UE may transmit a specific sequence using a preamble through a Physical Random Access Channel (PRACH) (S103 and S105) and receive a response message of the preamble through the PDCCH and the PDSCH corresponding thereto (S104 and S106). In the contention-based RACH, a contention resolution procedure may be additionally performed.

After performing the above-described procedures, the user equipment may receive a Physical Downlink Control Channel (PDCCH)/Physical Downlink Shared Channel (PDSCH) (S107), as a general uplink/downlink signal transmission procedure, and may then perform Physical Uplink Shared Channel (PUSCH)/Physical Uplink Control Channel (PUCCH) transmission (S108). The control information being transmitted by the user equipment to the base station is collectively referred to as Uplink Control Information (UCI). The UCI includes HARQ ACK/NACK (Hybrid Automatic Repeat and reQuest Acknowledgement/Negative-ACK), SR (Scheduling Request), CSI (Channel State Information), and so on. In the description of the present invention, the HARQ ACK/NACK will simply be referred to as HARQ-ACK or ACK/NACK (A/N). Herein, the HARQ-ACK includes at least one of a positive ACK (simply referred to as ACK), a negative ACK (simply referred to as NACK), a DTX, and an NACK/DTX. The CSI includes CQI (Channel Quality Indicator), PMI (Precoding Matrix Indicator), RI (Rank Indication), and so on.

In the LTE system, the UCI is generally transmitted through the PUCCH. However, when control information and traffic data are to be transmitted at the same time, the UCI may also be transmitted through the PUSCH. Additionally, based upon a network request/indication, the UCI may be aperiodically transmitted through the PUSCH.

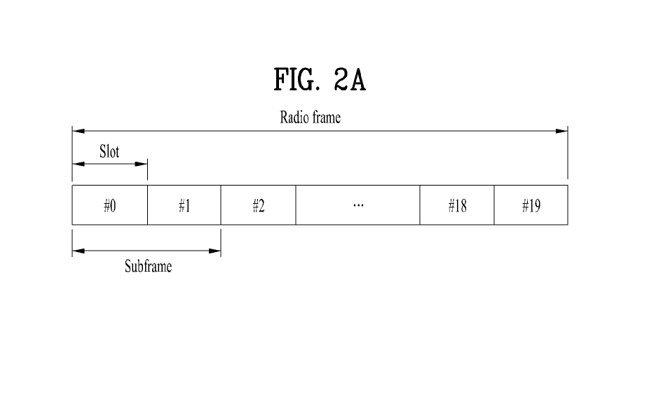

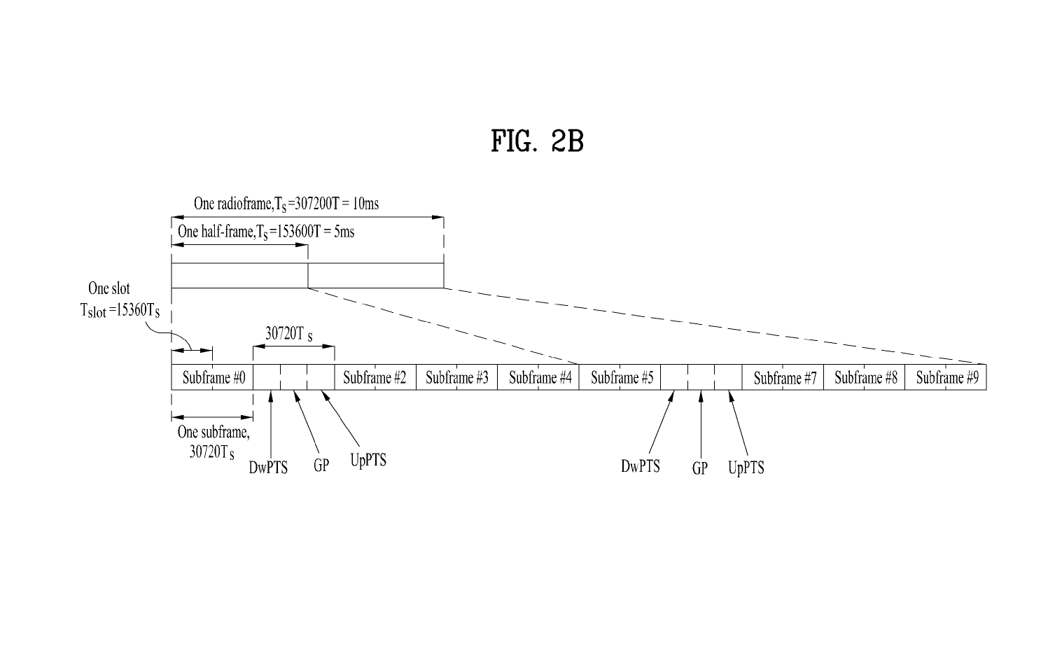

FIGS. 2A and 2B illustrate exemplary radio frame structures used in embodiments of the present disclosure.

FIG. 2A illustrates frame structure type 1. Frame structure type 1 is applicable to both a full Frequency Division Duplex (FDD) system and a half FDD system.

One radio frame is 10 ms (T_{f}=307200·Tₛ) long, including equal-sized 20 slots indexed from 0 to 19. Each slot is 0.5 ms (Tₛₗₒₜ=15360·Tₛ) long. One subframe includes two successive slots. An i^{th} subframe includes 2i^{th} and (2i+1)^{th} slots. That is, a radio frame includes 10 subframes. A time required for transmitting one subframe is defined as a Transmission Time Interval (TTI). Tₛ is a sampling time given as Tₛ=1/(15 kHz×2048)=3.2552×10⁻⁸ (about 33 ns). One slot includes a plurality of Orthogonal Frequency Division Multiplexing (OFDM) symbols or SC-FDMA symbols in the time domain by a plurality of Resource Blocks (RBs) in the frequency domain.

A slot includes a plurality of OFDM symbols in the time domain. Since OFDMA is adopted for DL in the 3GPP LTE system, one OFDM symbol represents one symbol period. An OFDM symbol may be called an SC-FDMA symbol or symbol period. An RB is a resource allocation unit including a plurality of contiguous subcarriers in one slot.

The above radio frame structure is purely exemplary. Thus, the number of subframes in a radio frame, the number of slots in a subframe, and the number of OFDM symbols in a slot may be changed.

FIG. 2B illustrates frame structure type 2. Frame structure type 2 is applied to a Time Division Duplex (TDD) system. One radio frame is 10 ms (T_{f}=307200·Tₛ) long, including two half-frames each having a length of 5 ms (=153600·Tₛ) long. Each half-frame includes five subframes each being 1 ms (=30720·Tₛ) long. An i^{th} subframe includes 2i^{th} and (2i+1)^{th} slots each having a length of 0.5 ms (Tₛₗₒₜ=15360·Tₛ). Tₛ is a sampling time given as Tₛ=1/(15 kHz×2048)=3.2552×10⁻⁸ (about 33 ns).

A type-2 frame includes a special subframe having three fields, Downlink Pilot Time Slot (DwPTS), Guard Period (GP), and Uplink Pilot Time Slot (UpPTS). The DwPTS is used for initial cell search, synchronization, or channel estimation at a UE, and the UpPTS is used for channel estimation and UL transmission synchronization with a UE at an eNB. The GP is used to cancel UL interference between a UL and a DL, caused by the multi-path delay of a DL signal.

[Table 1] below lists special subframe configurations (DwPTS/GP/UpPTS lengths).

TABLE 1

| | Normal cyclic prefix in downlink | | | Extended cyclic prefix in downlink | | |
|---|---|---|---|---|---|---|
| | | UpPTS | | | UpPTS | |
| | | Normal | Extended | | Normal | Extended |
| Special | | cyclic | cyclic | | cyclic | cyclic |
| subframe | | prefix in | prefix in | | prefix in | prefix in |
| configuration | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

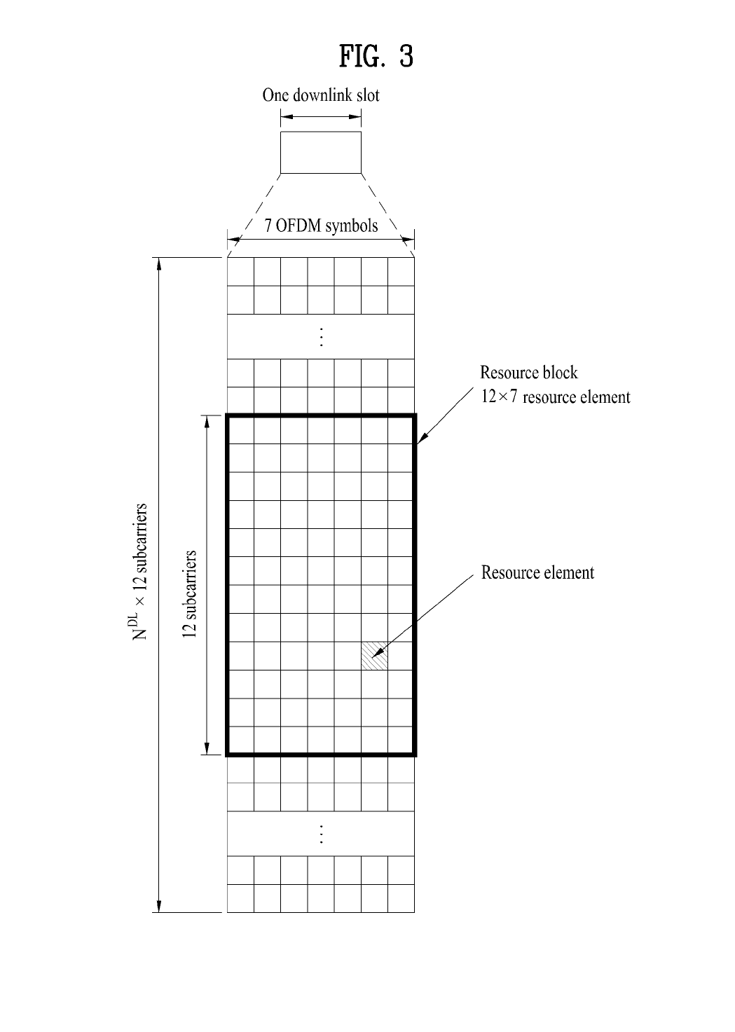

FIG. 3 illustrates an exemplary structure of a DL resource grid for the duration of one DL slot, which may be used in embodiments of the present disclosure.

Referring to FIG. 3, a DL slot includes a plurality of OFDM symbols in the time domain. One DL slot includes 7 OFDM symbols in the time domain and an RB includes 12 subcarriers in the frequency domain, to which the present disclosure is not limited.

Each element of the resource grid is referred to as a Resource Element (RE). An RB includes 12×7 REs. The number of RBs in a DL slot, N^{DL} depends on a DL transmission bandwidth. A UL slot may have the same structure as a DL slot.

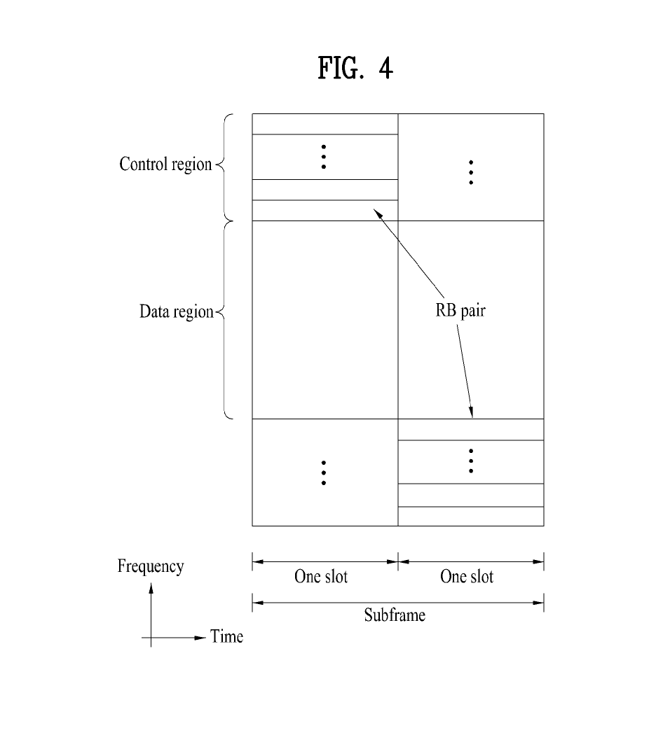

FIG. 4 illustrates a structure of a UL subframe which may be used in embodiments of the present disclosure.

Referring to FIG. 4, a UL subframe may be divided into a control region and a data region in the frequency domain. A PUCCH carrying UCI is allocated to the control region and a PUSCH carrying user data is allocated to the data region. To maintain a single carrier property, a UE does not transmit a PUCCH and a PUSCH simultaneously. A pair of RBs in a subframe are allocated to a PUCCH for a UE. The RBs of the RB pair occupy different subcarriers in two slots. Thus it is said that the RB pair frequency-hops over a slot boundary.

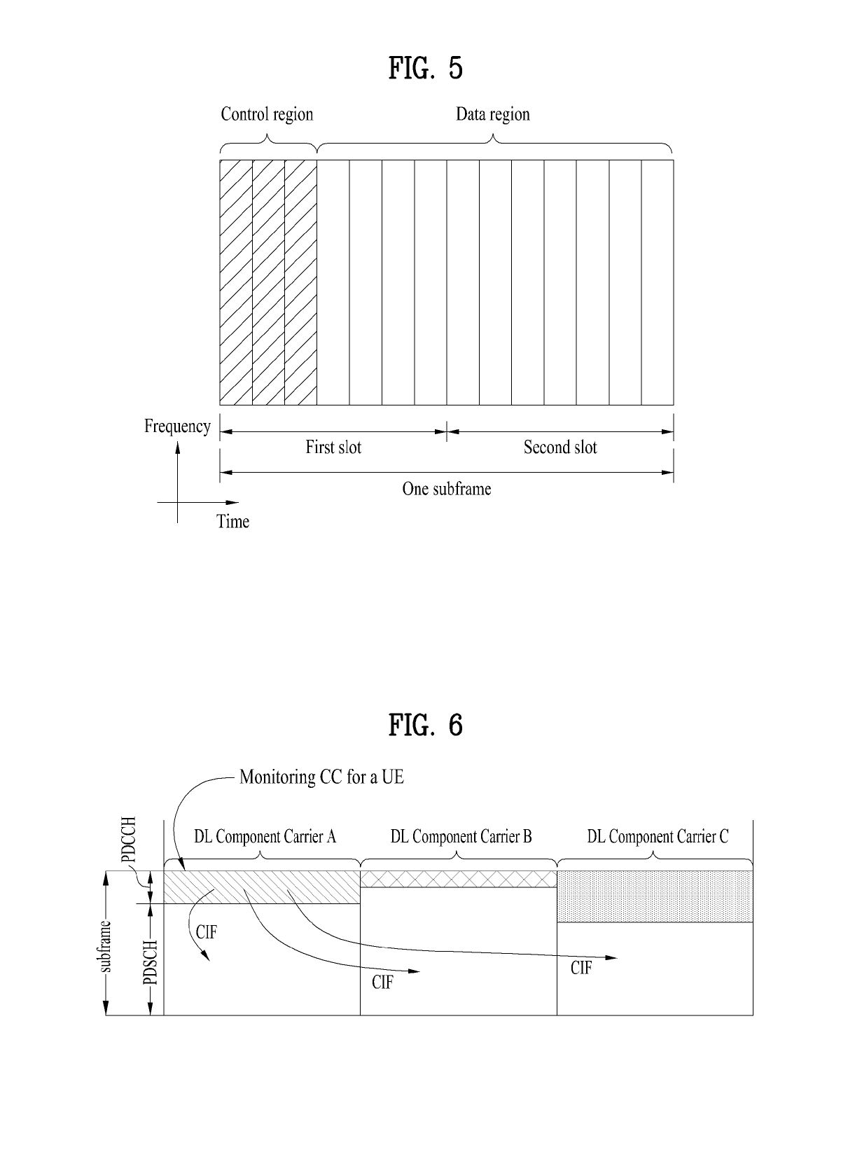

FIG. 5 illustrates a structure of a DL subframe that may be used in embodiments of the present disclosure.

Referring to FIG. 5, up to three OFDM symbols of a DL subframe, starting from OFDM symbol 0 are used as a control region to which control channels are allocated and the other OFDM symbols of the DL subframe are used as a data region to which a PDSCH is allocated. DL control channels defined for the 3GPP LTE system include a Physical Control Format Indicator Channel (PCFICH), a PDCCH, and a Physical Hybrid ARQ Indicator Channel (PHICH).

The PCFICH is transmitted in the first OFDM symbol of a subframe, carrying information about the number of OFDM symbols used for transmission of control channels (i.e. the size of the control region) in the subframe. The PHICH is a response channel to a UL transmission, delivering an HARQ ACK/NACK signal. Control information carried on the PDCCH is called Downlink Control Information (DCI). The DCI transports UL resource assignment information, DL resource assignment information, or UL Transmission (Tx) power control commands for a UE group.

A 3^{rd} generation partnership project long term evolution (3GPP LTE; Rel-8 or Rel-9) system (hereinafter, an LTE system) uses a multi-carrier modulation (MCM) method for segmenting and using a single component carrier (CC) into a plurality of bands. However, a 3GPP LTE-advanced system (e.g., Rel-10 or Rel-11; hereinafter, an LTE-A system) may use a method such as carrier aggregation (CA) for combining and using one or more components in order to support a wider band of system bandwidth than the LTE system. The term CA may be replaced with the terms carrier aggregation, carrier matching, multi component carrier (Multi-CC) environment or multicarrier environment.

In the present invention, multi-carrier means carrier aggregation (or carrier combining). Carrier aggregation covers aggregation of non-contiguous carriers as well as aggregation of contiguous carriers. In addition, the number of CCs that are aggregated in downlink and uplink may be configured in different ways. A case in which the number of downlink component carriers (hereinafter, “DL CC”s) and the number of uplink component carriers (hereinafter, “UL CC”s) are the same is referred to as symmetric aggregation, and a case in which the number of downlink CCs and the number of uplink CCs are different is referred to as asymmetric aggregation.

The term carrier aggregation is interchangeably used with bandwidth aggregation, spectrum aggregation, etc. The LTE-A system aims to support a bandwidth of up to 100 MHz by use of carrier aggregation configured by aggregating two or more CCs. To guarantee backward compatibility with a legacy IMT system, each of one or more carriers, which has a smaller bandwidth than a target bandwidth, may be limited to a bandwidth used in the legacy system.

For example, the legacy 3GPP LTE system supports bandwidths {1.4, 3, 5, 10, 15, and 20 MHz} and the 3GPP LTE-A system may support a broader bandwidth than 20 MHz using these LTE bandwidths. A CA system of the present invention may support carrier aggregation by defining a new bandwidth irrespective of the bandwidths used in the legacy system.

In addition, the above CA may be classified into intra-band CA and inter-band CA. The intra-band CA refers to a method in which a plurality of DL CCs and/or UL CCs is positioned adjacently or contiguously. In other words, CA may refer to a method in which carrier frequencies of DL CC and/or UL CCs are positioned in the same band. On the other hand, an environment that is far away from the frequency domain may be referred to as inter-band CA. In other words, CA may refer to a method in which carrier frequencies of a plurality of DL CCs and/or UL CCs are positioned in different bands. In this case, a UE may use a plurality of radio frequency (RF) end in order to perform communication in a CA environment.

An LTE-A system uses the concept of a cell in order to manage a wireless resource. The aforementioned CA environment may refer to a multiple cell environment. A cell is defined as a combination of a pair of downlink resource (DL CC) and an uplink resource (UL CC) but is not a necessary element. Accordingly, a cell may include a downlink resource alone or a downlink resource and an uplink resource.

For example, when a specific UE has only one configured serving cell, the UE may has one DL CC and one UL CC, but when a specific UE has two or more configured serving cells, the UE may have DL CCs, the number of which corresponds to the number of the cells, and the number of UL CCs may be equal to or smaller than the number of DL CCs. Alternatively, DL CCs and UL CCs may be configured in an opposite way. That is, when a specific UE has a plurality of configured serving cells, a CA environment in which the number of DL CCs is greater than the number of UL CCs may also be supported.

In addition, CA can be understood as aggregation of two or more cells with different carrier frequencies (center frequencies of cells). Here, the term ‘cell’ needs to be distinguished from a ‘cell’ that is a generally-used geographical area covered by an eNB. Hereinafter, the aforementioned intra-band CA may be referred to as intra-band multicell and the aforementioned inter-band CA may be referred to as inter-band multicell.

A cell used in the LTE-A system includes a primary cell (PCell) and a secondary cell (SCell). The PCell and the SCell may be used as serving cells. If the UE is in RRC_CONNECTED state but carrier aggregation has not been configured or is not supported in the UE, only one serving cell including a PCell exists for the UE. On the other hand, if the UE is in RRC_CONNECTED state and carrier aggregation has been configured for the UE, one or more serving cells may exist for the UE. The total serving cells include a PCell and one or more SCells.

The serving cells (the Pcell and the S cell) may be configured via an RRC parameter. PhysCellId is a physical layer ID of a cell and has an integer of 0 to 503. SCellIndex is a short ID used for identifying the S cell and has an integer of 1 to 7. ServCellIndex is a short ID for identifying the serving cell (the P cell or the S cell) and has an integer of 0 to 7. 0 is applied to the P cell and SCellIndex is pre-given so as to be applied to the S cell. That is, a cell having a smallest cell ID (or a cell index) of ServCellIndex is the P cell.

The P cell refers to a cell that operates at a primary frequency (or a primary CC). The P cell may be used to perform an initial connection establishment procedure or a connection reconfiguration procedure via a UE and refer to a cell indicated during a handover procedure. In addition, the P cell is a cell serving as a center of control-related communication among cells configured in a CA environment. That is, a UE may be allocated with a PUCCH only in a P cell of the UE and transmit the PUCCH. In addition, the UE may use only the P cell to acquire system information or change a monitoring procedure. Evolved universal terrestrial radio access (E-UTRAN) may change only the P cell for a handover procedure using an RRCConnectionReconfigutaion message of an upper layer, containing mobilityControlInfo in a UE that supports a CA environment.

The S cell may refer to a cell that operates at a secondary frequency (or a secondary CC). Only one P cell may be allocated to a specific UE and one or more S cells may be allocated to the UE. The S cell can be configured after RRC connection is established and used to supply additional radio resources. Among serving cells configured in the CA environment, a PUCCH is not present in cells except for P cells, that is, S cells.

When S cells are added to the UE that supports the CA environment, the E-UTRAN may supply all system information related to an operation of a related cell in RRC_CONNECTED state through a dedicated signal. Change in the system information may be controlled according to release and addition of related S cells. In this case, an RRCConnectionReconfigutaion message of an upper layer may be used. The E-UTRAN may perform dedicated signaling with different parameters for respective UEs instead of broadcasting in related S cells.

After an initial security activation procedure is initiated, the E-UTRAN may add one or more S cells to a P cell that is initially configured during a connection establishment procedure to configure a network including one or more S cells. In a CA environment, the P cell and the S cell may act as component carriers. In the following embodiments of the present invention, a primary component carrier (PCC) may have the same meaning as the P cell and a secondary component carrier (SCC) may have the same meaning as the S cell.

In a carrier aggregation (CA) system, from a point of view of scheduling on a serving cell or carrier, there are two methods, i.e., self-scheduling and cross carrier scheduling. The cross carrier scheduling may refer to cross component carrier scheduling or cross cell scheduling.

The self-scheduling refers to transmission of PDCCH (DL grant) and PDSCH via the same DL CC or transmission of PUSCH, transmitted on PDCCH (UL grant) transmitted via DL CC, via UL CC linked with DL CC for reception of UL grant.

The cross carrier scheduling refers to transmission of a PDCCH (DL grant) and PDSCH via different DL CCs or transmission of a PUSCH, transmitted on a PDCCH (UL grant) transmitted via a DL CC, via a UL CC that is not an UL CC linked with DL CC for reception of UL grant.

Whether to perform the cross carrier scheduling may be activated or deactivated UE-specifically or semi-statically known for each respective UE via upper layer signaling (e.g., RRC signaling).

When the cross carrier scheduling is activated, a PDCCH requires a carrier indicator field (CIF) indicating DL/UL CC for transmission of PDSCH/PUSCH indicated by the corresponding PDCCH. For example, the PDCCH may allocate PDSCH resources or PUSCH resources to one of a plurality of CCs using the CIF. That is, when the PDSCH or PUSCH resources are allocated to one of DL/UL CC via which PDCCH on DL CC is multiple-aggregated, the CIF is configured. In this case, a DCI format of Rel-8 may be extended according to the CIF. In this cast, the configured CIF may be fixed to a 3 bit field or fixed regardless of a DCI format size. In addition, a Rel-8 PDCCH structure (the same coding and same CCE-based resource mapping) may be reused.

On the other hand, when a PDCCH on a DL CC allocates PDSCH resources on the same DL CC or allocates PUSCH resources on single-linked UL CC, the CIF is not configured. In this case, the same PDCCH structure (the same coding and same CCE-based resource mapping) and the same DCI format as Rel-8 may be used.

When the cross carrier scheduling is possible, the UE needs to monitor a PDCCH of a plurality of DCIs in a control region of monitoring CC according to a transmission mode and/or bandwidth for each respective CC. Thus, PDCCH monitoring and configuration of a search space for supporting this are required.

In a multiple carrier system, a UE DL CC set is a set of DL CCs scheduled such that the UE receives a PDSCH and a UE UL CC set is a set of UL CCs scheduled such that the UE transmits a PUSCH. In addition, a PDCCH monitoring set is a set of at least one DL CC that performs the PDCCH monitoring. A PDCCH monitoring set may be the same as a UE DL CC or a subset of the UE DL CC set. The PDCCH monitoring set may include at least one of DL CCs in the UE DL CC set. Alternatively, the PDCCH monitoring set may be defined regardless of the UE DL CC set. A DL CC included in the PDCCH monitoring set may be configured such that self-scheduling with respect to UL CC linked with the DL CC is always possible. The UE DL CC set, the UE UL CC set, and the PDCCH monitoring set may be set UE-specifically, UE group-specifically, or cell-specifically.

When the cross component carrier scheduling is deactivated, the PDCCH monitoring set is always the same as the UE DL CC set. In this case, indication such as separate signaling with respect to the PDCCH monitoring set is not required. However, when the cross component carrier scheduling is activated, it is preferable that the PDCCH monitoring set is defined in the UE DL CC set. That is, in order to schedule a PDSCH or PUSCH for a UE, a BS transmits a PDCCH via the PDCCH monitoring set only.

FIG. 6 illustrates a subframe structure of an LTE-A system according to cross carrier scheduling.

Referring to FIG. 6, a DL subframe for an LTE-A UE is formed by combining three DL CCs and a DL CC ‘A’ is configured as a PDCCH monitoring DL CC. When a CIF is not used, each DL CC may transmit a PDCCH for scheduling a PDSCH thereof without a CIF. On the other hand, when the CIF is used via upper layer signaling, only one DL CC ‘A’ may transmit a PDSCH thereof or a PDCCH for scheduling a PDSCH of another CC using a CIF. In this case, DL CCs ‘B’ and ‘C’ that are not configured as a PDCCH monitoring DL CC do not transmit PDCCH.

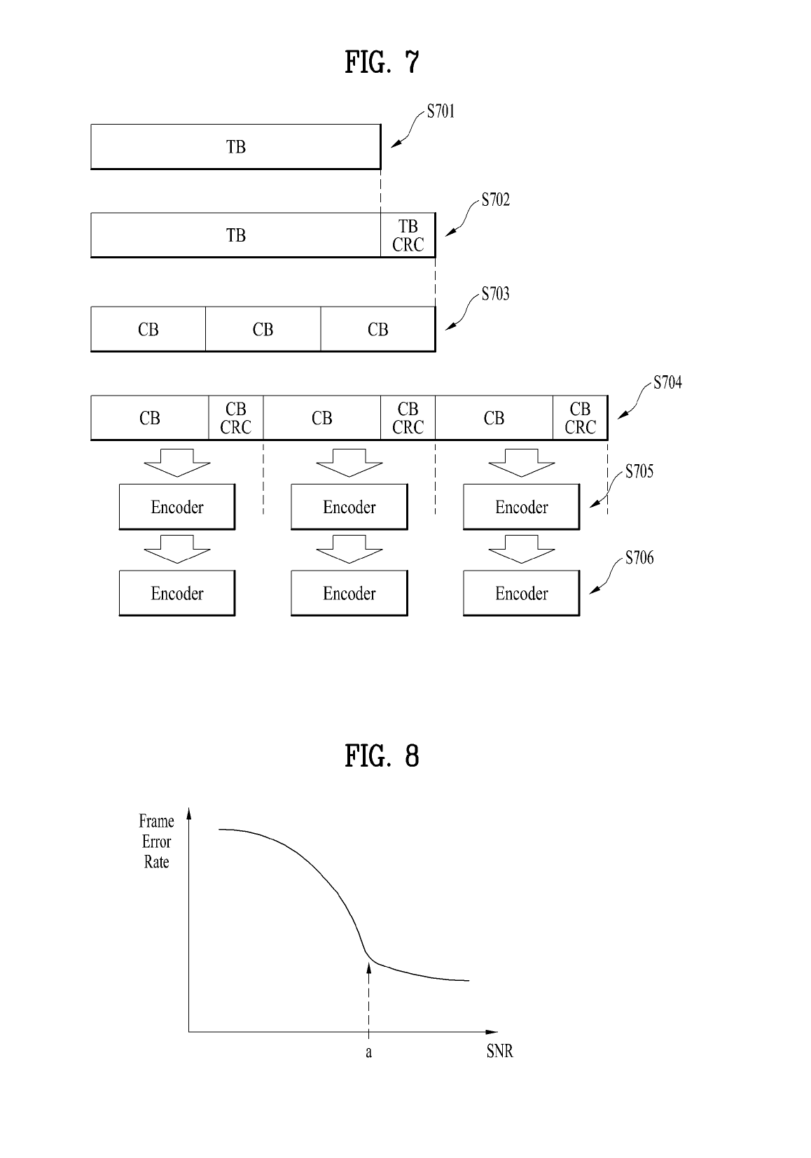

FIG. 7 is a diagram illustrating an encoding procedure according to an embodiment of the present invention.

The encoding procedure illustrated in FIG. 7 may also be applied to many channel codes including a turbo code used in the LTE communication system. Hereinafter, for convenience of description, an encoding procedure will be described based on terms according to the standard documents of the LTE communication system.

For example, the size of an input symbol may be different from the size of a transport block (TB) from a media access control (MAC) layer. When the size of the TB is larger than a maximum size of the input symbol of the turbo code, the TB may be segmented into a plurality of code blocks (CBs). According to the standard of the LTE communication system, the size of a CB may be equal to a value obtained by subtracting 6144 bits by a cyclic redundancy check (CRC) bit. An input symbol of a turbo code may be defined as data including a CB and CRC or data including a TB (e.g., a TB is less than 6144 bits) and CRC. A CRC bit may be a much smaller value (e.g., a maximum of 24 bits) than 6144 bits. Accordingly, hereinafter, unless otherwise defined, a CB may refer to a CB itself or a CRC bit corresponding to the CB, and a TB may refer to a TB itself or a CRC bit corresponding to the TB.

In the example of FIG. 7, first, a TB may be generated (S701). In addition, a CRC bit (TB CRC) is added to a TB (S702). Code block segmentation may be performed on the TB to which the CRC bit is added (S703). In addition, a CRC bit (CB CRC) may be added to each segmented CB (S704). In this case, for example, a size of a CB and corresponding CRC bit may be configured with 6144 bits. Encoding may be applied to each block including a CB and a corresponding CRC bit by an encoder (S705). For example, as described above, turbo coding may be applied. Modulation may be performed on each encoded CB (including a CRC bit) (S706).

A decoding procedure may be performed in an opposite order to the encoding procedure illustrated in FIG. 7. For example, a receiving end may perform decoding in units of code blocks using a decoder corresponding to each respective encoder, may lastly configure one TB, and check whether CRC of a TB is passed.

A turbo code may be a high-performance forward error correction (FEC) code and has been used in a LTE communication system. For example, a data block coded by the turbo code may include three sub blocks. One sub block may correspond to payload data of m bits. Another sub block may include parity bits of n/2 bits with respect to payload, calculated using a recursive systematic convolution (RSC) code. In addition, the remaining sub blocks may include parity bits of n/2 bits with respect to permutation of payload data, calculated using a RSC code. For example, the aforementioned permutation may be performed by an interleaver. Accordingly, two sub blocks of different parity bits as well as a payload may be configured as one block. For example, when m is the same as n/2, one block may have a code rate of ⅓.

A turbo code may provide error correction performance that approaches a theoretical limit of Shannon while having a comparatively simple structure. However, as illustrated in FIG. 8, when an error rate exceeds a specific SNR (e.g., a), additional enhancement in decoding performance is slight. That is, the turbo code has an error-floor in which additional enhancement in an error rate is slight when an error rate exceeds a predetermined SNR.

In order to overcome this problem, two methods may be considered. For example, use of a code by which error-floor does not occur compared with the current turbo code may be considered. In addition, for example, a concatenate code formed by adding overhead to the current turbo code may be used.

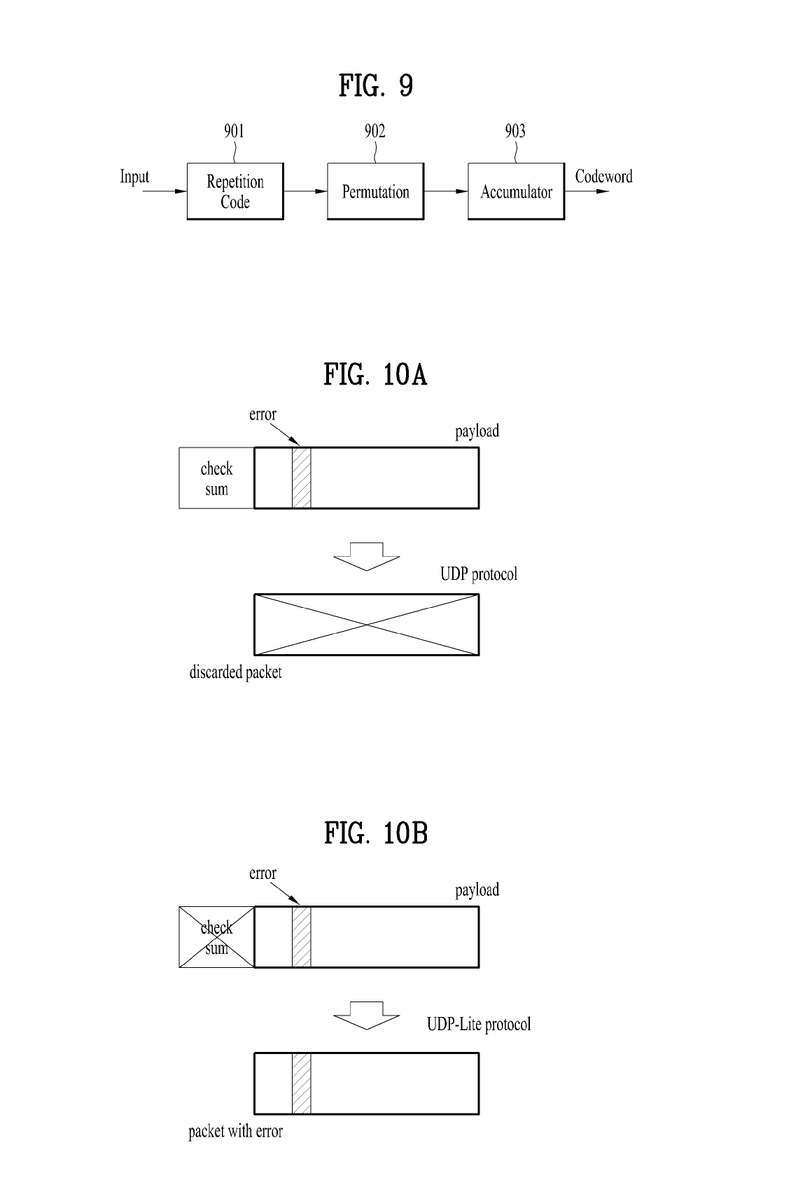

As an example of concatenate code, a repeat-accumulate (RA) code may be used. FIG. 9 illustrates an example of an RA code encoder. A concatenate code such as an RA code may include two encoders with simple structures (e.g., a repetition code 901 and an accumulator 903) and one processing (e.g., a permutation 902) applied between the encoders.

For example, the RA code encoder may repeat data a preset number of times and permutate the repeated data with a permutation matrix. Here, the permutation may be performed by an interleaver. An accumulator may accumulate information items in data to encode the permutated data ion.

The RA code may have remarkably low complexity while having similar performance to the turbo code. Overall performance of concatenate code including an RA code may be enhanced as the number of concatenated codes is increased or as performance of each concatenate code is further excellent.

Accordingly, in order to reduce occurrence of error-floor, an RA code may be also applied to the current turbo code. As such, overhead may not be added using the concatenate code, and instead, a turbo code with a higher code rate than a currently configured code rate of an LTE communication system may be used, and a code (e.g., a Reed-Solomon code) with high complexity and excellent performance may be applied instead of the RA code.

FIG. 10A illustrates processing of error data according to a UDP protocol and FIG. 10B illustrates processing of error data according to a UDP-Lite protocol.

In order to increase transmission speed, as a method for reducing end-to-end delay between a transmitting end and a receiving end, a UDP-lightweight (Lite) user datagram protocol has been considered.

In a conventional UDP protocol illustrated in FIG. 10A, when error is present in a payload, the corresponding payload may be discarded. However, in a system using the UDP-Lite, a payload may be transmitted in a state in which some symbols in the payload correspond to error using partial checksum, as illustrated in FIG. 10B.

For example, in the case of multimedia data, when checksum error occurs, all corresponding packets may be discarded in a system using UDP. In this case, for example, in the case of video data, the error may cause picture freeze. On the other hand, a system using UDP-Lite may transmit a packet to a higher layer while error is present, which may cause only acceptable error (e.g., noise in an image). Accordingly, it may be advantageous to use a packet with error than a corresponding packet is discarded to correspond to error. Accordingly, for example, the UDP-Lite may be appropriate for the multimedia data transmitting system.

Protocols using CRC as well as a conventional UDP protocol and the like, all packets are discarded when the packets fail in checksum due to some error symbols in the packets. Accordingly, in particular, when the number of symbols with error in a packet is small in a physical layer, use of checksum may cause an insufficient result.

In general, data of a communication system may have a small payload size differently from multimedia data. For example, a CRC bit as 1 TB unit, and in this case, a size of information that is discarded due to the CRC error may be a minimum of 1 TB. Accordingly, it may be effective to apply an error correction code in a higher layer only when a payload in a higher layer is segmented into a large number of TBs. For example, when a payload size includes 1024 TBs, even if some TBs are discarded, an error correction code in a higher layer may be applied. However, for example, when a payload size includes 2 TBs, application of an error correction code in a higher layer may be meaningless because half of payload data is erased if one TB is discarded.

On the other hand, an error correction code may be effective when an appropriate number or more symbols are present. For example, in the case of an LTE turbo code, a meaningful result may be obtained when an input size is about 1000 bits (a maximum of 6144 bits) or more. Here, since an error correction code in a physical layer is processed in units of bits, 1 symbol may be considered as including 1 bit. Accordingly, when a payload includes a plurality of TBs in order to increase efficiency of an error correction code in a higher layer, since a size of each TB is reduced, efficiency of an error correction code in a lower layer (e.g., a physical layer) may be reduced.

In the case of a current communication system, for example, an LTE (A) communication system, a turbo code may be applied to a physical layer. In addition, similarly to the aforementioned UDP protocol, when error occurs in a physical layer, a corresponding TB may be discarded and a retransmission request of the corresponding TB may be transmitted to a transmitting end.

However, in the case of high-speed communication, a re-transmission scheme may cause excessive time delay. The time delay may generate excessive signal overhead as well as may reduce communication speed. Accordingly, like the aforementioned UDP-Lite protocol, enhancement in communication performance by attempting error correction using a TB with error may be considered.

When a re-transmission scheme for high-speed communication is not used, there is a limit in performance of error correction in a physical layer. Accordingly, in order to compensate for this, an error correction code in a higher layer may be applied. In addition, since decoding complexity in a higher layer is remarkably lower than a physical layer, a method for simultaneously using a higher layer error correction code and a physical layer correction code will be proposed hereinafter.

For decoding in a physical layer, a likelihood ratio may be used. For example, a log-likelihood ratio (LLR) may be calculated according to Equation 1 below.

$$L L R ( b ) = log \frac{p ( z \vert b = + 1 )}{p ( z \vert b = - 1 )} \qquad [ Equation 1 ]$$

In Equation 1 above, b refers to a bit value modulated in a transmitting end and z refers to a reception bit. An additive white Gaussian noise (AWGN) channel has a probability density function such as Equation 2 below.

$$\frac{1}{σ \sqrt{2 π}} exp ( \frac{{( x - μ )}^{2}}{2 {σ}^{2}} ) \qquad [ Equation 2 ]$$

In Equation 2 above, x refers to a received bit, μ refers to an average value, σ refers to a standard deviation, and σ² refers to a variance. Accordingly, p(z|b=+1) and p(z|b=−1) of Equation 1 above may each have the same form as Equation 2 above. In the case of p(z|b=+1), with respect to +1 may be used, and in the case of p(z|b=−1), μ with respect to −1 may be used. However, the two values share the same channel, and thus the same σ may be obtained. Accordingly, log may be applied to the two values to remove an exponential function. As a result, Equation 1 above may use a Euclidean distance between a received bit and a modulated bit to simplify calculation.

According to the present embodiment, channel code decoding error in a physical layer may be determined based on LLR such as Equation 1 above. For example, when a transmitting end transmits a bit corresponding to ‘+1’, a receiving end may determine whether error occurs in a received bit according to Equation 3 below.

$$\begin{matrix}P ( E ) = P ( b = - 1 \vert b = + 1 ) \\ = P \{ p ( z \vert b = - 1 ) > p ( z \vert b = + 1 ) \} \\ = P \{ log p ( z \vert b = - 1 ) > log p ( z \vert b = + 1 ) \} \\ = P \{ log \frac{p ( z \vert b = + 1 )}{p ( z \vert b = - 1 )} < 0 \}\end{matrix} \qquad [ Equation 3 ]$$

In Equation 3 above, P(E) refers to error possibility and as a result, refers to possibility that Equation 4 below is satisfied.

$$log \frac{p ( z \vert b = + 1 )}{p ( z \vert b = - 1 )} < 0 \qquad [ Equation 4 ]$$

Accordingly, in the present embodiment, error due to physical layer channel code may be recognized using Equation 4 above. In addition, even if CRC failure occurs with respect to a TB, the corresponding TB may be transmitted to a higher layer together with a position of the bit that is recognized as an error bit using the above equation. Error of a TB can be checked via CRC but an accurate bit with error cannot be checked via CRC.

Accordingly, a threshold value may be set and a value less than the threshold value may be considered as error. For example, when the threshold value is set to α (here, α is a real value equal to or more than 0), error may be determined according to Equation 5 below.

$$\vert log \frac{p ( z \vert b = + 1 )}{p ( z \vert b = - 1 )} \vert < α \qquad [ Equation 5 ]$$

By deriving an absolute value from Equation 4, error possibility of an input value may be determined according to Equation 5 above. For example, when a value of Equation 5 above is less than α, this means that distances of ‘+1’ and ‘−1’ with respect to a value of an input signal does not have a big difference. Accordingly, this may mean that error possibility is high compared with the case in which a value of Equation 5 above is equal to or more than α.

Summarizing Equation 5 above using Equation 2 above, it may be seen that Equation 5 above means that a Euclidean distance between an input signal and an average value of +1 and a Euclidean distance between the input signal and an average value of −1 has a difference equal to or less than the threshold value.

As a signal-to-noise ratio (SNR) of a receiving channel is increased, α may be set to be higher. This is because, when an SNR is high, whether error occurs can be more strictly determined.

In addition, an error correction code of a higher layer may consider 1 symbol as 1 bit, and error code correction can be effectively performed in an effective code length range like a physical layer code.

In addition, in the above embodiment, CRC may be checked with respect to only a header instead of an entire payload. In addition, when CRS fails with respect to a header, CRC may be consider to fail with respect to an entire payload.

When CRC fails with respect to a TB or a header, a bit recognized as an error bit may be erased and a corresponding TB together with information about the recognized error bit (e.g., positional information) may be transmitted to a higher layer. Accordingly, since the higher layer recognizes a position of the bit recognized as an error bit, error correction can be achieved using an error correction code applied to the higher layer. In addition, since the higher layer can achieve error correction using only exclusive OR (XOR) calculation, error can be corrected via simpler calculation. Error correction in a higher layer may have shorter transmission delay than retransmission of error data. In addition, since information of an error bit in a physical layer is transmitted together, error can be corrected using a data payload with an effective size. In addition, a higher layer may perform error correction to perform error correction with low complexity.

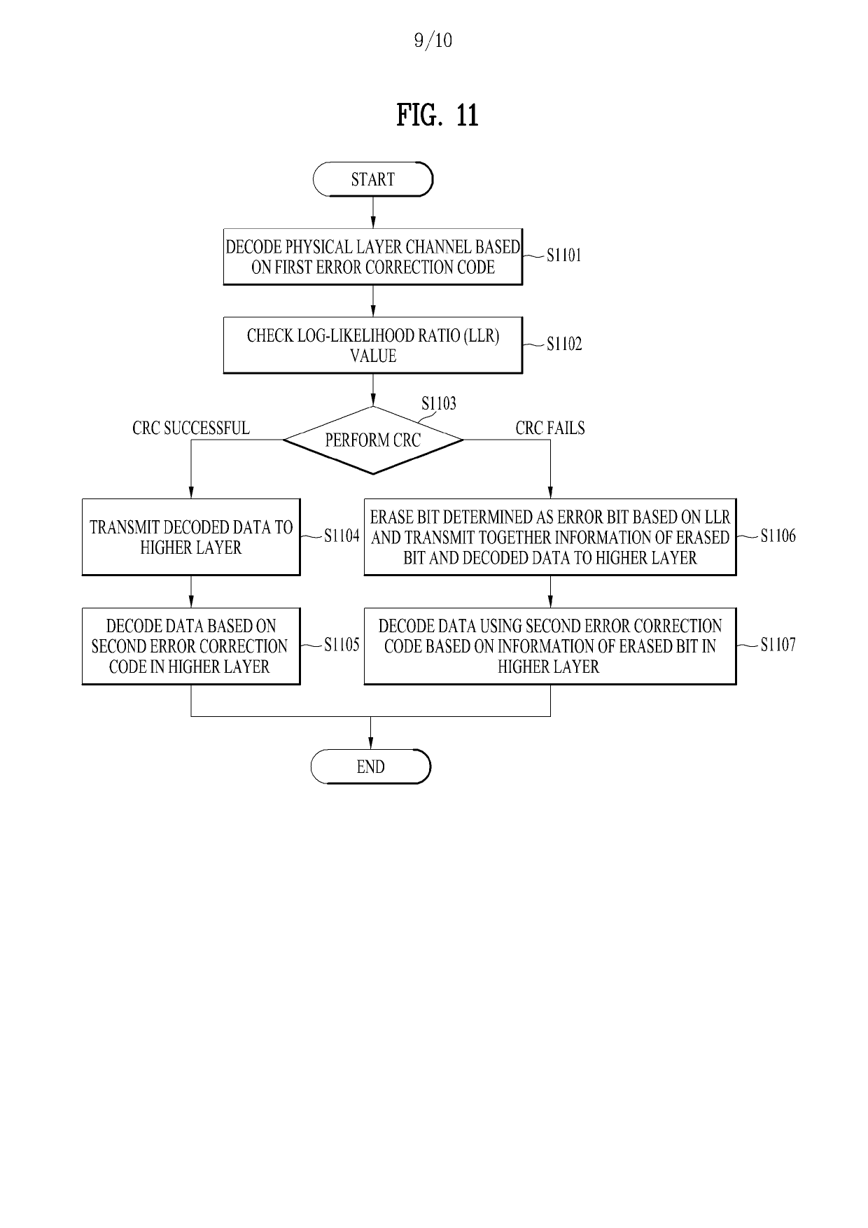

FIG. 11 is a flowchart of a decoding method according to an embodiment of the present invention.

First, a physical layer channel may be decoded based on a first error correction code (S1101). As described above, the physical layer channel may be decoded based on various error correction codes. For example, the physical layer channel may be decoded based on an LTE turbo code.

An LLR value may be checked with respect to the data (e.g., a TB) decoded in the physical layer (S1102). The LLR value may be calculated based on at least one of Equations 1 to 7 above. In addition, when the LLR value is less than a specific value, a corresponding bit may be determined as an error bit and a position of the corresponding bit may be recognized. Then, CRC may be performed on a TB (S1103). In the present embodiment, CRC may be performed only on a header of data rather than being performed on a TB. When CRC is successful, the decoded data may be transmitted to a higher layer (S1104). In addition, the higher layer may decode a higher layer channel based on a second error correction code (S1105). As described above, the higher layer channel may be decoded based on various error correction codes. For example, the higher layer channel may be decoded based on an RA code.

When CRC fails with respect to the TB, a bit determined as an error bit may be erased based on LLR, and information (e.g., a position of the corresponding erased bit) together with the decoded data may be transmitted to a higher layer (S1106). In addition, data may be decoded using a second error correction code based on information about the erased bit (S1107).

The embodiment of FIG. 11 is for explanation of an embodiment and may be combined with other aforementioned embodiments. For example, the aforementioned first error correction code and/or second error correction code may be a turbo code, an RA code, an RS code, or a polar code. In addition, the aforementioned embodiments may be applied to an arbitrary communication system and/or broadcast system.

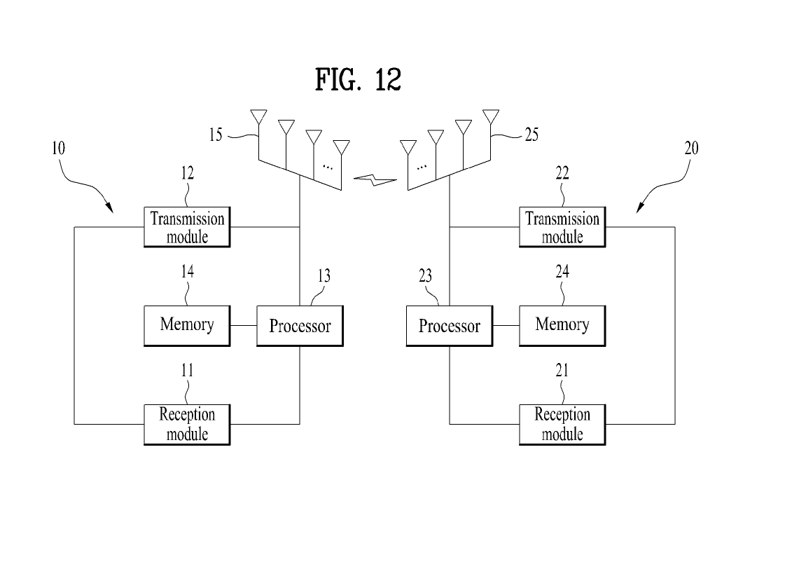

FIG. 12 is a schematic diagram for explanation of components of apparatuses to which the embodiments of the present invention of FIGS. 1 to 11 are applicable, according to an embodiment of the present invention.

Referring to FIG. 12, a BS apparatus 10 according to the present invention may include a receiving module 11, a transmitting module 12, a processor 13, a memory 14, and a plurality of antennas 15. The transmitting module 12 may transmit various signals, data, and information to an external apparatus (e.g., a UE). The receiving module 11 may receive various signals, data, and information from an external apparatus (e.g., a UE). The receiving module 11 and the transmitting module 12 may each be referred to as a transceiver. The processor 13 may control an overall operation of the BS apparatus 10. The antennas 15 may be configured according to, for example, 2-dimensional (2D) antenna arrangement.

The processor 13 of the BS apparatus 10 according to an embodiment of the present invention may be configured to receive channel state information according to proposed embodiments of the present invention. In addition, the processor 13 of the BS apparatus 10 may perform a function for calculating and processing information received by the BS apparatus 10 and information to be externally transmitted, and the memory 14 may store the calculated and processed information for a predetermined time period and may be replaced with a component such as a buffer (not shown) or the like.

Referring to FIG. 12, a UE apparatus 20 according to the present invention may include a receiving module 21, a transmitting module 22, a processor 23, a memory 24, and a plurality of antennas 25. The antennas 25 refer to a terminal apparatus for supporting MIMO transmission and reception. The transmitting module 22 may transmit various signals, data, and information to an external apparatus (e.g., an eNB). The receiving module 21 may receive various signals, data, and information from an external apparatus (e.g., an eNB). The receiving module 21 and the transmitting module 22 may each be referred to as a transceiver. The processor 23 may control an overall operation of the UE apparatus 20.

The processor 23 of the UE apparatus 20 according to an embodiment of the present invention may be configured to transmit channel state information according to proposed embodiments of the present invention. In addition, the processor 23 of the UE apparatus 20 may perform a function for calculating and processing information received by the UE apparatus 20 and information to be externally transmitted, and the memory 24 may store the calculated and processed information for a predetermined time period and may be replaced with a component such as a buffer (not shown) or the like.

The aforementioned components of the BS apparatus 10 and the UE apparatus 20 may be embodied by independently applying the above description of the present invention or simultaneously applying two or more embodiments of the present invention, and a repeated description is not given for clarity.

In addition, with regard to the various embodiments of the present invention, although an example in which a downlink transmission entity or an uplink reception entity is an eNB and a downlink reception entity or an uplink transmission entity is a UE has been described, the scope of the present invention is not limited thereto. For example, the above description of the eNB may be applied in the same way to the case in which a cell, an antenna port, an antenna port group, an RRH, a transmission point, a reception point, an access point, a relay, etc. are a downlink transmission entity to a UE or an uplink reception entity from the UE. In addition, the principle of the present invention that has been described with regard to the various embodiments of the present invention may also be applied in the same way to the case in which a relay is a downlink transmission entity to a UE or an uplink reception entity to a UE or the case in which a relay is an uplink transmission entity to an eNB or a downlink reception entity from an eNB.

The embodiments of present invention are applicable to various wireless access systems and broadcast communication systems. Examples of the various wireless access systems may include a 3rd generation partnership project (3GPP), 3GPP2, and/or institute of electrical and electronic engineers 802 (IEEE 802).xx system. The embodiments of present invention are applicable to any technological fields that apply the various wireless access systems as well as the various wireless access systems.

According to the embodiments of the present invention, the following advantages may be achieved.

An effective error correction method that does not require retransmission by applying an error correction code to both a physical layer and a higher layer may be provided.

A position of error may be determined based on a log-likelihood ratio (LLR) in a physical layer and transmitted to a higher layer so as to achieve effective error correction in the higher layer.

Error correction performance may be enhanced while using a conventional turbo code.

In addition, an error correction method with low complexity and high error correction performance via error correction code and error symbol information exchange of a physical layer and a higher layer may be provided.

The embodiments of the present invention may be achieved by various means, for example, hardware, firmware, software, or a combination thereof.

In a hardware configuration, an embodiment of the present invention may be achieved by one or more application specific integrated circuits (ASICs), digital signal processors (DSPs), digital signal processing devices (DSDPs), programmable logic devices (PLDs), field programmable gate arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by a subsequent amendment after the application is filed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for decoding data of a receiving end, the method comprising:
receiving data from a transmitting end;
decoding, in a physical layer, a transport block from the received data based on a first error correction code;
determining whether error occurs in each of symbols in the transport block based on a log-likelihood ratio (LLR) for each of the symbols;
performing cyclic redundancy check (CRC) on the transport block;
when the CRC fails, transmitting a transport block in which at least one symbol determined as error is erased and information about the at least one erased symbol to a higher layer; and
decoding, in the higher layer the transmitted transport block based on the information about the at least one erased symbol according to a second error correction code.

2. The method as claimed in claim 1, wherein the first error correction code is a turbo code.

3. The method as claimed in claim 1, wherein the second error correction code is a repetition accumulate (RA) code, a Reed-Solomon (RS) code, or a polar code.

4. The method as claimed in claim 1, wherein the performing of the CRC comprises performing the CRC on the entire transport block or a header of the transport block.

5. The method as claimed in claim 1, wherein each of the symbols is configured with 1 bit having a first value or a second value.

6. The method as claimed in claim 5, wherein the determining of whether error occurs in each of the symbols comprises determining that the symbol as error when an absolute value of a difference between a first Euclidean distance between a value of a symbol and an average value of the first value and a second Euclidean distance between a value of the symbol and an average value of the second value is less than a preset threshold value.

7. The method as claimed in claim 6, wherein:
the determining of whether error occurs in each of the symbols is performed according to the following equation,
$$\vert log \frac{p ( z \vert b = + 1 )}{p ( z \vert b = - 1 )} \vert < α$$
where b is a bit value modulated in the transmitting end, z is a symbol in the transport block, and α is the preset threshold value; and
a possibility function p has a form of additive white Gaussian noise (AWGN).

8. The method as claimed in claim 6, wherein the preset threshold value is set to be increased as a signal-to-noise ratio (SNR) of a channel that receives the data is increased.

9. A receiver comprising:
a transceiver configured to transmit and receive a signal; and
a processor configured to control the transceiver,
wherein the processor is further configured to receive data from a transmitting end, configured to decode a transport block from the received data based on a first error correction code in a physical layer, configured to determine whether error occurs in each of symbols in the transport block based on a log-likelihood ratio (LLR) for each of the symbols, configured to perform cyclic redundancy check (CRC) on the transport block, configured to, when the CRC fails, transmit together a transport block in which at least one symbol determined as error is erased and information about the at least one erased symbol, to a higher layer, and configured to decode the transmitted transport block based on the information about the at least one erased symbol according to a second error correction code, in the higher layer.

10. The receiver as claimed in claim 9, wherein:
the first error correction code is a turbo code; and
the second error correction code is a repetition accumulate (RA) code, a Reed-Solomon (RS) code, or a polar code.

11. The receiver as claimed in claim 9, wherein CRC on the transport block is performed on the entire transport block or a header of the transport block.

12. The receiver as claimed in claim 9, wherein each of the symbols is configured with 1 bit having a first value and a second value.

13. The receiver as claimed in claim 12, wherein whether error occurs in each of the symbols is determined by determining that the symbol as error when an absolute value of a difference between a first Euclidean distance between a value of a symbol and an average value of the first value and a second Euclidean distance between a value of the symbol and an average value of the second value is less than a preset threshold value.

14. The receiver as claimed in claim 13, wherein:
whether error occurs in each of the symbols is determined according to the following equation,
$$\vert log \frac{p ( z \vert b = + 1 )}{p ( z \vert b = - 1 )} \vert < α$$
where b is a bit value modulated in the transmitting end, z is a symbol in the transport block, and α is the preset threshold value; and
a possibility function p has a form of additive white Gaussian noise (AWGN).

15. The receiver as claimed in claim 13, wherein the preset threshold value is set to be increased as a signal-to-noise ratio (SNR) of a channel that receives the data is increased.
